(19) United States
(12) Patent Application Publication
(10) Pub. No.: US 2006/0045383 A1
(43) Pub. Date: Mar. 2, 2006

(54) Displacement estimation system and method

(76) Inventors: Carl E. Picciotto, Menlo Park, CA (US); Jun Geo, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/930,206

(22) Filed: Aug. 31, 2004

(51) Int. Cl. G06K 9/32; G06K 9/00

(52) U.S. Cl. 382/294; 382/151

(57) ABSTRACT

A system comprising a data acquisition system and a processing system is provided. The data acquisition system is configured to capture an image that includes a first instance of a pattern and a second instance of the pattern from at least a first substrate, and the processing system is configured to calculate a displacement between the first instance and the second instance using the image.

### CROSS-REFERENCE TO RELATED APPLICATIONS

This application is related to U.S. patent application Ser. No. ______, Docket No. 200403527-1, filed concurrently herewith, entitled DISPLACEMENT ESTIMATION SYSTEM AND METHOD and U.S. patent application Ser. No. ______, Docket No. 200403700-1, filed concurrently herewith, entitled DISPLACEMENT ESTIMATION SYSTEM AND METHOD. Each of the above U.S. Patent Applications is assigned to the assignee of the present invention, and is hereby incorporated by reference herein.

### BACKGROUND

Various systems exist for the purpose of positioning one or more substrates in one or more locations to allow operations to be performed on the substrate or substrates. Some systems, such as alignment systems, attempt to position substrates by directly aligning one or more patterns on the substrates with the goal of a zero-length displacement. Moiré patterns or other particular patterns such as a box and a cross may be used for this purpose.

With existing alignment systems, the positioning of substrates may be poorly quantized and may not be useful in instances where a non-zero displacement is desired. It would be desirable to be able to accurately quantize the position or positions of substrates.

### SUMMARY

One form of the present invention provides a system comprising a data acquisition system and a processing system. The data acquisition system is configured to capture an image that includes a first instance of a pattern and a second instance of the pattern from at least a first substrate, and the processing system is configured to calculate a displacement between the first instance and the second instance using the image.

### BRIEF DESCRIPTION OF THE DRAWINGS

FIG. 1 is a block diagram illustrating a displacement estimation system according to one embodiment of the present invention.

FIG. 2 is a flow chart illustrating a method for calculating a displacement according to one embodiment of the present invention.

FIG. 3 is a block diagram illustrating a substrate with multiple instances of a pattern according to one embodiment of the present invention.

FIG. 4 is a block diagram illustrating substrates with multiple instances of a pattern according to one embodiment of the present invention.

FIG. 5 is a block diagram illustrating substrates with multiple instances of a pattern according to one embodiment of the present invention.

FIG. 6 is a block diagram illustrating substrates with multiple instances of a pattern according to one embodiment of the present invention.

FIG. 7 is a block diagram illustrating a displacement adjustment system according to one embodiment of the present invention.

FIG. 8 is a flow chart illustrating a method for calculating and using a displacement according to one embodiment of the present invention.

FIG. 9 is a block diagram illustrating a displacement adjustment system according to one embodiment of the present invention.

FIG. 10 is a flow chart illustrating a method for calculating and using a displacement according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

A system and method for determining the relative positioning between instances of a pattern in one or more substrates through the use of image displacement calculations are provided. The image displacement calculations involve the process of identifying the instances of the pattern and estimating the distance between the instances to calculate a displacement. The displacement may be used to move the substrates into exacting relative positions or may be used to move a function unit, such as a piece of fabrication equipment, relative to the substrate or substrates.

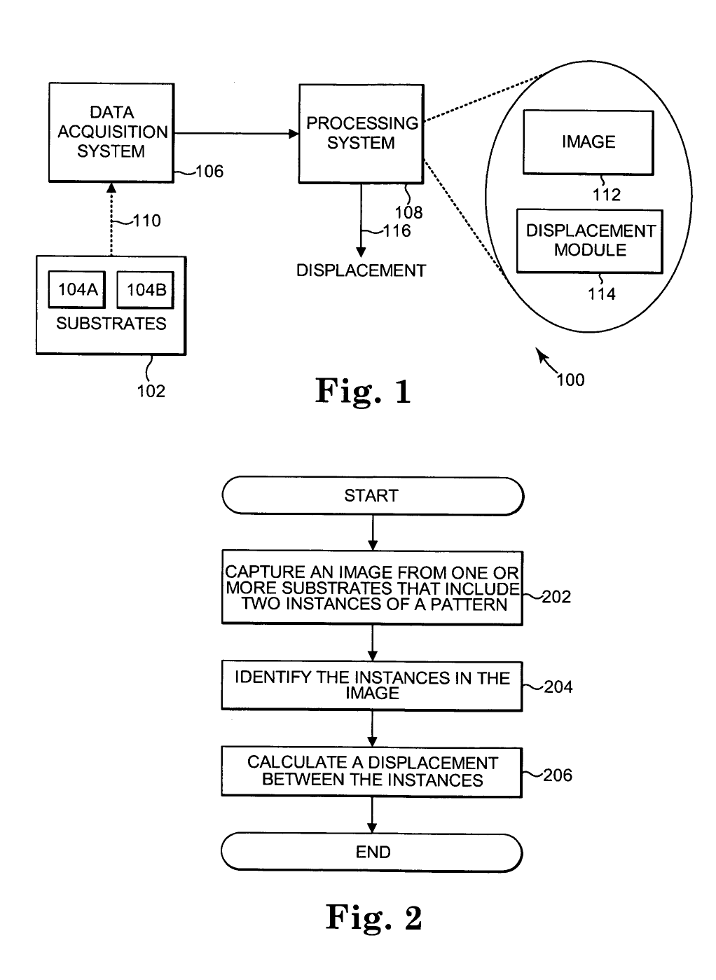

FIG. 1 is a block diagram illustrating one embodiment of a displacement estimation system 100. Displacement estimation system 100 comprises one or more substrates 102 that include at least two instances of a pattern 104A and 104B, a data acquisition system 106, and a processing system 108.

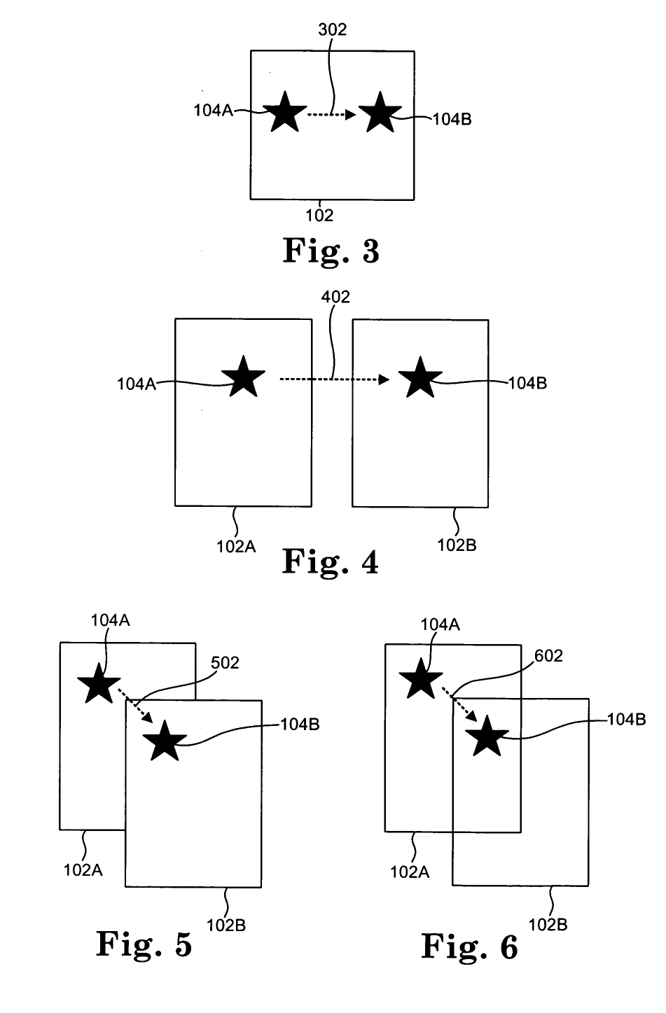

Substrate or substrates 102 include at least two instances of a pattern 104A and 104B. Instances 104A and 104B may be located on one substrate 102, as illustrated and described with respect to FIG. 3 below, or multiple substrates, as illustrated and described with respect to FIGS. 4-6 below. Substrates 102 may be any suitable one, two, or three dimensional work object such as a silicon or other type of semiconductor wafer, paper, and a web of material. The term “web of material” covers both a web of material that carries objects (e.g., a conveyor) and the surface of a work object that is moveable relative to displacement estimation system 100.

Each instance of the pattern 104A and 104B comprises any feature or set of features that is formed or naturally occurring on substrate 102. Instances of the pattern 104A and 104B are sufficiently identical to allow consistent displacement calculations. The pattern may be naturally occurring on substrate 102 or man-made and may include broad-area features of substrate 102, whether the features cover a large or small area of substrate 102. The patterns may be created as a result of a fabrication process or produced concurrently to the use of this invention.

Data acquisition system 106 comprises any suitable optical or non-optical system configured to acquire data from substrates 102 to form an image 112 such that image 112 may be used to identify the relative locations of instances 104A and 104B. Examples of optical systems include one or more cameras or other devices configured to optically capture image 112. Examples of non-optical systems include electron beam devices or other devices configured to capture image 112 using non-optical means. Data acquisition system 106 has a resolution and a scale appropriate for the type of substrate 102. The resolution may be pixel, sub-pixel, or another suitable resolution, and the scale may be nanoscale or another suitable resolution. Image 112 comprises any set of optical or non-optical data that may be used to identify the relative locations of instances 104A and 104B.

In operation, data acquisition system 106 captures an image 112 of substrate or substrates 102 that includes instances of the pattern 104A and 104B as indicated by a dashed arrow 110 and provides image 112 to processing system 108.

Processing system 108 receives and stores image 112, and processes the image 112 using a displacement module 114. Using displacement module 114, processing system 108 identifies or locates instances 104A and 104B in image 112, and calculates a displacement between instances 104A and 104B as indicated by an arrow 116. Processing system 108 identifies or locates instances 104A and 104B by searching for instances 104A and 104B in selected regions of image 112. The regions may be selected from anticipated locations of instances 104A and 104B. The regions may be searched using coarse searching algorithms to locate general regions where instances 104A and 104B are located and then using fine searching algorithms to locate the specific regions where instances 104A and 104B are located. Processing system 108 may calculate the displacement to a pixel or a sub-pixel resolution. In some embodiments, processing system 108 generates a reference image (not shown) that includes instance 104A and a comparison image (not shown) that includes 104B. In these embodiments, processing system 108 calculates a displacement between instances 104A and 104B using the reference and comparison images.

Displacement module 114 may embody any suitable algorithm for calculating the displacement between instances 104A and 104B. Suitable algorithms may include an image cross-correlation algorithm, a phase delay detection algorithm, or other displacement estimation algorithms.

With the image cross-correlation algorithm, displacement module 114 uses image cross-correlations to calculate the displacement. One example of an image cross-correlation algorithm is a nearest neighbor navigation algorithm. With the nearest neighbor navigation algorithm, displacement module 114 uses image cross-correlations or comparison functions which approximate or parallel pixel-by-pixel correlation functions to calculate the displacement. The nearest neighbor navigation algorithm uses very short correlation distances in calculating the displacement. Additional details of nearest neighbor navigation algorithms may be found in U.S. Pat. No. 5,149,980 entitled “SUBSTRATE ADVANCE MEASUREMENT SYSTEM USING CROSS-CORRELATION OF LIGHT SENSOR ARRAY SIGNALS” listing Ertel et al. as inventors and U.S. Pat. No. 6,195,475 entitled “NAVIGATION SYSTEM FOR HANDHELD SCANNER” listing Beausoleil et al. as inventors. Each of these patents is assigned to the assignee of the present invention, and is hereby incorporated by reference herein.

With the phase delay detection algorithm (and other similar phase correlation methods) displacement module 114 processes images converted to a frequency domain representation and draws equivalences between phase delays and displacements to calculate the displacement.

Functions performed by processing system 108 and/or displacement module 114 may be implemented in hardware, software, firmware, or any combination thereof. The implementation may be via a microprocessor, programmable logic device, or state machine. Components of the present invention, e.g., displacement module 114, may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

FIG. 2 is one embodiment of a flow chart illustrating a method for calculating a displacement. The method shown in FIG. 2 may be implemented by displacement estimation system 100. Referring to FIGS. 1 and 2, data acquisition system 106 captures image 112 from one or more substrates 102 that include at least two instances of the pattern 104A and 104B as indicated in a block 202. Displacement module 114 identifies the instances of the pattern 104A and 104B as indicated in a block 204. Displacement module 114 calculates a displacement between the instances of the pattern 104A and 104B as indicated in a block 206.

FIG. 3 is one embodiment of a block diagram illustrating a single substrate 102 with instances of the pattern 104A and 104B. In the embodiment shown in FIG. 3, data acquisition system 106 captures image 112 such that image 112 includes instances 104A and 104B. Image 112 may include all or only a portion of substrate 102. Displacement module 114 calculates a displacement, as represented by a dashed arrow 302, between instances 104A and 104B. Accordingly, instances 104A and 104B may be included in the same substrate 102 as shown in FIG. 3.

FIG. 4 is one embodiment of a block diagram illustrating substrates 102A and 102B with multiple instances of the pattern 104A and 104B. Substrates 102A and 102B are separated by a finite distance, as shown, such that the substrates 102A and 102B do not overlap from the perspective of data acquisition system 106. In the embodiment shown in FIG. 4, data acquisition system 106 captures image 112 such that image 112 includes instances 104A and 104B. Image 112 may include all or only a portion of substrate 102A and all or only a portion of substrate 102B. Displacement module 114 calculates a displacement, as represented by a dashed arrow 402, between instances 104A and 104B. Accordingly, instances 104A and 104B may be included in different substrates 102A and 102B that are separated by a finite distance as shown in FIG. 4.

FIG. 5 is one embodiment of a block diagram illustrating substrates 102A and 102B with multiple instances of the pattern 104A and 104B. Substrates 102A and 102B overlap from the perspective of data acquisition system 106 and are opaque to data acquisition system 106, as shown. In the embodiment shown in FIG. 5, data acquisition system 106 captures image 112 such that image 112 includes instances 104A and 104B. Image 112 may include all or only a portion of substrate 102A and all or only a portion of substrate 102B. Displacement module 114 calculates a displacement, as represented by a dashed arrow 502, between instances 104A and 104B. Accordingly, instances 104A and 104B may be included in different substrates 102A and 102B that overlap and are opaque as shown in FIG. 5.

FIG. 6 is one embodiment of a block diagram illustrating substrates 102A and 102B with multiple instances of the pattern 104A and 104B. Substrates 102A and 102B overlap from the perspective of data acquisition system 106 and are transparent to data acquisition system 106, as shown. In the embodiment shown in FIG. 6, data acquisition system 106 captures image 112 such that image 112 includes instances 104A and 104B. Image 112 may include all or only a portion of substrate 102A and all or only a portion of substrate 102B. Displacement module 114 calculates a displacement, as represented by a dashed arrow 602, between instances 104A and 104B. Accordingly, instances 104A and 104B may be included in different substrates 102A and 102B that overlap and are transparent as shown in FIG. 6.

In the embodiments shown in FIGS. 4-6, substrates 102A and 102B may preferably be in the same focal plane to avoid lateral movement uncertainties or magnification variations which may occur when changing focus or moving data acquisition system 106.

In other embodiments, data acquisition system 106 may include two independent data acquisition systems, e.g., two cameras, located at a fixed distance from one another. In such an embodiment, data acquisition system 106 captures two images (not shown) such that at least one pattern appears in each image. Data acquisition system 106 provides the two images to processing system 108, and processing system 108 identifies the patterns in the images and calculates the displacement between patterns according to the fixed distance between cameras.

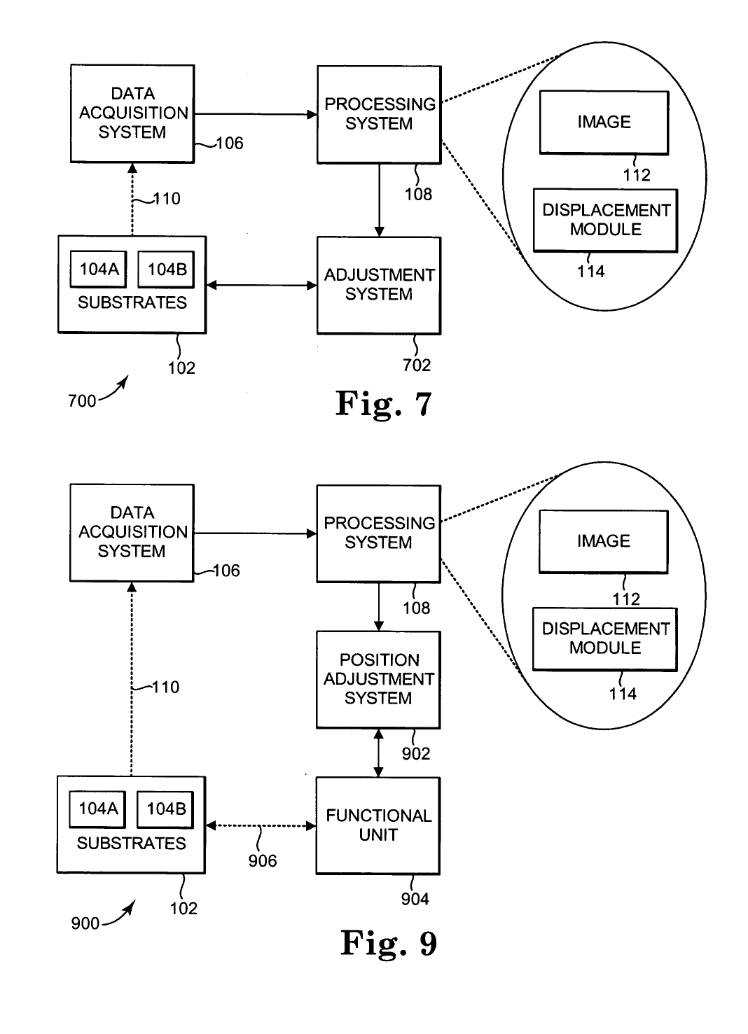

FIG. 7 is one embodiment of a block diagram illustrating a displacement adjustment system 700. Displacement adjustment system 700 comprises one or more substrates 102 that include at least two instances of the pattern 104A and 104B, data acquisition system 106, processing system 108, and an adjustment system 702. In the embodiment of FIG. 7, adjustment system 702 receives the displacement from processing system 108 and adjusts the position of one or more substrates 102 according to a value of the displacement. The value represents a distance value that indicates a distance between instances of the pattern 104A and 104B.

FIG. 8 is one embodiment of a flow chart illustrating a method for calculating and using a displacement. The method shown in FIG. 8 may be implemented by displacement adjustment system 700. Referring to FIGS. 7 and 8, data acquisition system 106 captures image 112 from one or more substrates 102 that include at least two instances of the pattern 104A and 104B as indicated in block 202. Displacement module 114 identifies the instances of the pattern 104A and 104B as indicated in block 204. Displacement module 114 calculates a displacement between the instances of the pattern 104A and 104B as indicated in block 206. Adjustment system 702 adjusts the position of substrate or substrates 102 using the displacement as indicated in a block 802. A determination is made by processing system 108 as to whether to perform another iteration as indicated in block 804. If another iteration is to be performed, then the functions of blocks 202 through 804 are repeated. If another iteration is not to be performed, then the method ends.

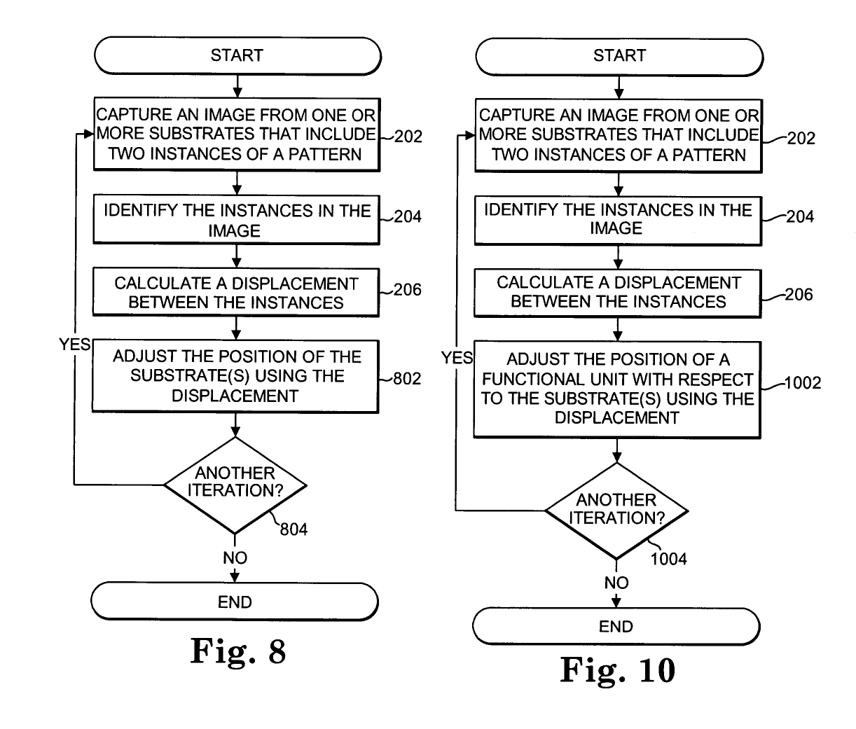

FIG. 9 is one embodiment of a block diagram illustrating a displacement adjustment system 900. Displacement adjustment system 900 comprises one or more substrates 102 that include at least two instances of the pattern 104A and 104B, data acquisition system 106, processing system 108, a position adjustment system 902, and at least one functional unit 904. In the embodiment of FIG. 9, position adjustment system 902 receives the displacement from processing system 108 and adjusts the position of functional unit 904 relative to substrate or substrates 102 according to the value of the displacement. Functional unit 904 may be any system or apparatus configured to perform an operation on substrate or substrates 102.

FIG. 10 is one embodiment of a flow chart illustrating a method for calculating and using a displacement. The method shown in FIG. 10 may be implemented by displacement adjustment system 900. Referring to FIGS. 9 and 10, data acquisition system 106 captures image 112 from one or more substrates 102 that include at least two instances of the pattern 104A and 104B as indicated in block 202. Displacement module 114 identifies the instances of the pattern 104A and 104B as indicated in block 204. Displacement module 114 calculates a displacement between the instances of the pattern 104A and 104B as indicated in block 206. Position adjustment system 902 adjusts the position of functional unit 904 with respect to substrate or substrates 102 using the displacement as indicated in a block 1002. A determination is made by processing system 108 as to whether to perform another iteration as indicated in block 1004. If another iteration is to be performed, then the functions of blocks 202 through 1004 are repeated. If another iteration is not to be performed, then the method ends.

Displacement estimation system 100 and displacement adjustment systems 700 and 900 may be used in a wide variety of applications. The applications include lithography such as optical lithography, imprint or contact lithography, and nanoimprint lithography.

Embodiments described herein may provide advantages over previous alignment systems. For example, substrates may be positioned without the need to overlay patterns on top of each other. In addition, center lines may not need to be calculated. Further, patterns may not need to be symmetric.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
a data acquisition system; and
a processing system;
wherein the data acquisition system is configured to capture an image that includes a first instance of a pattern and a second instance of the pattern from at least a first substrate, and wherein the processing system is configured to calculate a displacement between the first instance and the second instance using the image.

2. The system of claim 1 wherein the data acquisition system is configured to provide the image to the processing system, and wherein the processing system is configured to identify the first instance and the second instance.

3. The system of claim 1 further comprising:
an adjustment system configured to receive the displacement from the processing system;
wherein the adjustment system is configured to adjust a position of the first substrate using the displacement.

4. The system of claim 1 further comprising:
a position adjustment system configured to receive the displacement from the processing system;
wherein the position adjustment system is configured to adjust a position of a functional unit relative to the first substrate using the displacement.

5. The system of claim 1 wherein the data acquisition system is configured to capture the image that includes the first instance of the pattern from the first substrate and the second instance of the pattern from a second substrate.

6. The system of claim 5 wherein the first substrate is separated from the second substrate such that the first substrate and the second substrate do not overlap from the perspective of the data acquisition system.

7. The system of claim 5 wherein the first substrate overlaps the second substrate from the perspective of the data acquisition system.

8. The system of claim 7 wherein the first substrate and the second substrate are opaque to the data acquisition system.

9. The system of claim 7 wherein the first substrate and the second substrate are transparent to the data acquisition system.

10. The system of claim 1 wherein the first substrate is selected from the group consisting of a semiconductor wafer, paper, and a web of material.

11. The system of claim 1 wherein the pattern comprises a man-made pattern.

12. The system of claim 1 wherein the pattern naturally occurs on the first substrate.

13. The system of claim 1 wherein the data acquisition system comprises an optical system.

14. The system of claim 13 wherein the data acquisition system comprises at least one camera.

15. The system of claim 1 wherein the data acquisition system comprises a non-optical system.

16. The system of claim 1 wherein processing system is configured to calculate the displacement according to a resolution selected from the group consisting of pixel resolution and sub-pixel resolution.

17. A method comprising:
capturing an image that includes a first instance of a pattern and a second instance of the pattern from at least a first substrate;
identifying the first instance and the second instance of the pattern in the image; and
calculating a displacement between the first instance and the second instance of the pattern using the image.

18. The method of claim 17 further comprising:
adjusting a first position of the first substrate using the displacement.

19. The method of claim 18 further comprising:
capturing the image that includes the first instance of the pattern and the second instance of the pattern from the first substrate and a second substrate; and
adjusting a second position of the second substrate using the displacement.

20. The method of claim 17 further comprising:
adjusting a position of a functional unit with respect to the first substrate using the displacement.

21. The method of claim 20 further comprising:
capturing the image that includes the first instance of the pattern and the second instance of the pattern from the first substrate and a second substrate; and
adjusting the position of the functional unit with respect to the second substrate using the displacement.

22. The method of claim 17 further comprising:
generating a reference image from the image;
generating a comparison image from the image; and
calculating the displacement by comparing the reference image with the comparison image.

23. A system comprising:
means for capturing an image that includes a first instance of a pattern and a second instance of the pattern from at least a first substrate; and
means for calculating a displacement between the first instance and the second instance of the pattern using the image.

24. The system of claim 23 further comprising:
means for adjusting a position of the first substrate using the displacement.

25. The system of claim 23 wherein the means for capturing the image includes means for capturing the image such that the image includes the first instance of the pattern from the first substrate and the second instance of the pattern from the second substrate.

26. The system of claim 25 wherein the first substrate is separated from the second substrate such that the first substrate and the second substate do not overlap from the perspective of the means for capturing the image.

27. The system of claim 25 wherein the first substrate overlaps the second substrate from the perspective of the means for capturing the image.

28. The system of claim 27 wherein the first substrate and the second substrate are opaque to the means for capturing the image.

29. The system of claim 27 wherein the first substrate and the second substrate are transparent to the means for capturing the image.

30. The system of claim 23 wherein the first substrate is selected from the group consisting of a semiconductor wafer, paper, and a web of material.

31. The system of claim 23 wherein the pattern comprises a man-made pattern.

32. The system of claim 23 wherein the pattern naturally occurs on the first substrate.

33. A computer-readable medium having computer-executable instructions for performing a method of calculating a displacement, comprising:
receiving an image that comprises a first instance of a pattern and a second instance of the pattern embodied in at least one substrate;
identifying the first instance and the second instance of the pattern in the image; and
calculating the displacement between the first instance and the second instance of the pattern using the image.

34. The computer-readable medium of claim 33 wherein the computer-readable medium has computer-executable instructions for:
providing the displacement to an adjustment system that is configured to adjust a position of the at least one substrate using the displacement.

35. The computer-readable medium of claim 33 wherein the computer-readable medium has computer-executable instructions for:
providing the displacement to a position adjustment system configured to adjust a position of a functional unit with respect to the at least one substrate using the displacement.

36. The computer-readable medium of claim 33 wherein the computer-readable medium has computer-executable instructions for:
generating a reference image from the image;
generating a comparison image from the image; and
calculating the displacement by comparing the reference image with the comparison image.
